(19) United States
(12) Patent Application Publication
(10) Pub. No.: US 2012/0016924 A1
(43) Pub. Date: Jan. 19, 2012

(54) METHOD AND SYSTEM FOR EMAIL ANALYTICS

(75) Inventors: Paul Farnell, Boston, MA (US); Matthew Brindley, Cambridge, MA (US); David Smalley, Leeds (GB)

(73) Assignee: SALTED SERVICES, INC., Cambridge, MA (US)

(21) Appl. No.: 13/181,346

(22) Filed: Jul. 12, 2011

Related U.S. Application Data
(60) Provisional application No. 61/363,982, filed on Jul. 13, 2010.

(51) Int. Cl. G06F 15/16

(52) U.S. Cl. 709/202

(57) ABSTRACT

An email campaign is analyzed by sending an email message including a tracking code that requests content from an initial-engagement location (e.g., a server). The tracking code requests the content from the initial-engagement location when the email message is opened by a mail user agent operated by a recipient. Requests sent to the initial-engagement location are then tracked to measure the number of recipients that open the email message. A first redirect response is then served from the initial-engagement location to the mail user agent of the recipient after a first delay period to cause the mail user agent of the recipient to then request content from a first redirect location; and requests sent to the first redirect location are tracked to measure the number of recipients that keep the email message open in the mail user agent for through all of the first delay period.

### RELATED APPLICATION

This application claims the benefit of U.S. Provisional Application No. 61/363,982, filed 13 Jul. 2010, the entire content of which is incorporated herein by reference.

### BACKGROUND

Electronic mail (email) has become a popular and effective tool for disseminating messages and other information to a group of recipients. For various reasons, the sender of an email message may want to know how many recipients actually reviewed the content of the email message. Consequently, tools have been developed, for example, to detect whether a recipient has opened an email message within a mail client. Such tools are valuable, for example, for marketing or management purposes to better understand whether the desired communication is being received.

### SUMMARY

An email campaign is analyzed by sending an email message including a tracking code that requests content from an initial-engagement location (e.g., a server). The tracking code requests the content from the initial-engagement location when the email message is opened by a mail user agent operated by a recipient. Requests sent to the initial-engagement location are then tracked to measure the number of recipients that open the email message. A first redirect response is then served from the initial-engagement location to the mail user agent of the recipient after a first delay period to cause the mail user agent of the recipient to then request content from a first redirect location; and requests sent to the first redirect location are tracked to measure the number of recipients that keep the email message open in the mail user agent for through all of the first delay period.

This method can be carried out using computers and a web-based server. And it can offer a more robust analysis of an email transmission, tracking not only whether an email message was opened by a recipient, but also for how long the email message was held open by the recipient, which can reveal, for example, whether the recipient (a) just glanced at the email message, (b) browsed the full contents of the email message or (c) studied the full content of the email message (e.g., word for word). This information can be valuable to the sender (or other party) in evaluating how widely and successfully the content of the email message was communicated to the recipients.

### BRIEF DESCRIPTION OF THE DRAWINGS

FIG. 1 provides a schematic illustration of communications from the server(s) to the client(s) as the email analytics are carried out in an embodiment of the method.

FIG. 2 is a flow chart of an embodiment of the email analytics method.

FIG. 3 is a view of a representative presentation (e.g., via a computer screen) of the output of the email analytics after an email message is sent to a plurality of recipients and recipient behavior is tracked.

### DETAILED DESCRIPTION

### Introduction

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise defined, terms (including technical and scientific terms) used herein have the same meaning as commonly understood by one of ordinary skill in the art to which the invention belongs. It will be further understood that terms, such as those defined in commonly used dictionaries, are to be interpreted as having a meaning that is consistent with their meaning in the context of the relevant art and are not to be interpreted in an idealized or overly formal sense unless expressly so defined herein.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Additionally, in this disclosure, when an element is referred to as being “on,” “connected to” or “coupled to” another element, it may be directly on, connected or coupled to the other element or intervening elements may be present unless otherwise specified.

Moreover, the present invention is not limited to any particular computer hardware, protocol, operating system, software applications, browser code, etc., but rather is applicable to numerous alternatives in computing, including, for example, new mail user agents or transfer protocols not yet implemented.

The terminology used herein is for the purpose of describing particular embodiments and is not intended to be limiting of exemplary embodiments. As used herein, singular forms, such as “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

### Computers, Software, Storage Media, and Other Components

The systems and methods of this disclosure can be implemented in a computing system environment. Examples of well known computing system environments and components thereof that may be suitable for use with the systems and methods include, but are not limited to, personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like. Typical computing system environments and their operations and components are described in many existing patents (e.g., U.S. Pat. No. 7,191,467, owned by Microsoft Corp.).

The methods may be carried out via non-transitory computer-executable instructions, such as program modules. Generally, program modules include routines, programs, objects, components, data structures, and so forth, that perform particular tasks or implement particular types of data. The methods may also be practiced in distributed computing environments where tasks are performed by remote processing devices that are linked through a communications network. In a distributed computing environment, program modules may be located in both local and remote computer storage media including memory storage devices.

The systems (e.g., of the “client” and “server”) and methods of this disclosure may utilize a computer to carry out the processes described herein. Components of the computer may include, but are not limited to, a computer processor, a computer storage medium serving as memory, and a system bus that couples various system components including the memory to the computer processor. The system bus can be of any of several types of bus structures including a memory bus or memory controller, a peripheral bus, and a local bus using any of a variety of bus architectures.

The computer typically includes a variety of computer-readable media accessible by the processor and including both volatile and nonvolatile media and removable and non-removable media. By way of example, computer-readable media can comprise computer-storage media and communication media.

The computer storage media stores the software and data in a non-transitory state and includes both volatile and nonvolatile, removable and non-removable media implemented in any method or technology for storage of software and data, such as computer-readable instructions, data structures, program modules or other data. Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can accessed by the computer.

The memory includes computer-storage media in the form of volatile and/or nonvolatile memory such as read only memory (ROM) and random access memory (RAM). A basic input/output system (BIOS), containing the basic routines that help to transfer information between elements within the computer, such as during start-up, is typically stored in the ROM. The RAM typically contains data and/or program modules that are immediately accessible to and/or presently being operated on by the processor.

The computer may also include other removable/non-removable, volatile/nonvolatile computer-storage media, such as (a) a hard disk drive that reads from or writes to non-removable, nonvolatile magnetic media; (b) a magnetic disk drive that reads from or writes to a removable, nonvolatile magnetic disk; and (c) an optical disk drive that reads from or writes to a removable, nonvolatile optical disk such as a CD ROM or other optical medium. The computer-storage medium can be coupled with the system bus by a communication interface, wherein the interface can include, e.g., electrically conductive wires and/or fiber-optic pathways for transmitting digital or optical signals between components. Other removable/non-removable, volatile/nonvolatile computer storage media that can be used in the exemplary operating environment include magnetic tape cassettes, flash memory cards, digital versatile disks, digital video tape, solid state RAM, solid state ROM, and the like.

The drives and their associated computer-storage media provide storage of computer-readable instructions, data structures, program modules and other data for the computer. For example, a hard disk drive inside or external to the computer can store an operating system, application programs, and program data.

The various processes described in the descriptions that follow can be encoded as software instructions in memory and executed by a processor to carry out the processes.

A user of the computer can enter commands and information into the computer through an input device, such as a keyboard; a pointing device (such as a mouse, trackball or touch-pad tablet); or a microphone. The input device can be connected to the processor through a communication interface coupled to the system bus and/or by another interface and bus structure, such as a parallel port or a universal serial bus (USB).

A monitor or other type of display device can also be connected to the system bus via a communication interface (e.g., a video interface). The monitor can also be integrated with a touch-screen panel or the like that can input digitized input, such as handwriting, into the computer system via a communication interface. In some embodiments, the monitor and/or touch screen panel can be physically coupled to or incorporated into a housing of the computer, such as in a tablet-type personal computer. In addition, the computer can also include other peripheral output devices, such as one or more speakers and printers, through a communication interface.

### Network Connections and Communications

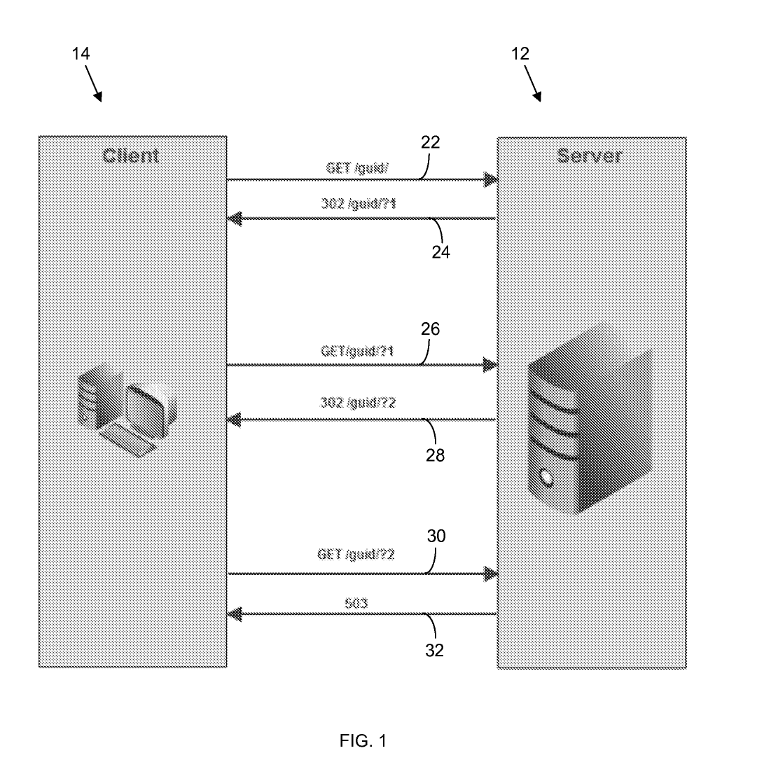

The computer can operate in a networked environment using logical connections from a server 12 to one or more remote client computers 14, as shown in FIG. 1. The remote computer can be a personal computer, a server, a router, a network PC, a peer device or other common network node, and typically includes many or all of the elements described relative to the above-described computer. The networked environment can include a local area network (LAN), a wide area network (WAN), and/or other networks. Such networking environments are commonplace in offices, enterprise-wide computer networks, intranets and the internet.

When used in a LAN networking environment, the computer is connected to the LAN through a network interface or adapter. When used in a WAN networking environment, the computer typically includes a modem for establishing communications over the WAN (e.g., over the internet). The modem, which can be internal or external to the computer housing, can be connected to the system bus via the user-input interface or other appropriate mechanism.

In an embodiment of a WAN environment, a user (via a client computer connected with and in communication with the internet) accesses one or more remote computer servers (also connected with and in communication with the internet) using, e.g., an internet browser (such as Internet Explorer from Microsoft, Firefox from Mozilla, or Chrome from Google) via hypertext transfer protocol (HTTP) communications or via communications generated and/or received by a software program, such as an email application (e.g., Microsoft Outlook) that can be stored in the computer's memory. The computer server can be a computer including memory storing a web server application, such as the Apache HTTP Server. The client computer can send an HTTP GET request to the server via the communication media that form the internet, and the participating server can respond to the client computer via the internet with an appropriate HTTP response.

HTTP is a request-response protocol standard for client-server computing. In HTTP, a personal computer running a web browser, for example, acts as a client, while a computer hosting a web site acts as a server. The client submits HTTP requests to the responding server by sending messages to it. The server, which stores content (or resources) such as HTML files and images, or generates such content on the fly, sends messages back to the client in response. These returned messages may contain the content requested by the client or may contain other kinds of response indications. Between the client and server there may be several intermediaries, such as proxies, web caches or gateways. In such a case, the client communicates with the server indirectly, and only converses directly with the first intermediary in the chain.

An HTTP request message from the client can include the following: (a) a Request line that requests a resource (such as an image); (b) Headers; (c) an empty line; and, optionally, (d) a message body. The HTTP Headers form the core of the HTTP request, as they define various characteristics of the data that is requested or the data that has been provided. The HTTP Headers can include a referrer that identifies, from the point of view of an internet webpage or resource, the address of the webpage (e.g., the URL) of the resource that links to it. By checking the referrer, the new page can determine the source of the request message. A variety of different request protocols exists; for example, a “GET request” requests a representation of the specified resource from the host.

### Email

Electronic mail (email) is a popular and common form of communication involving clients and servers over the internet. An email message can transmit a communication from a sender to one or more recipients. The email message includes a message header and a message body. The message header contains control information, including, minimally, an originator's email address and one or more recipient addresses. The message body includes the content of the email message.

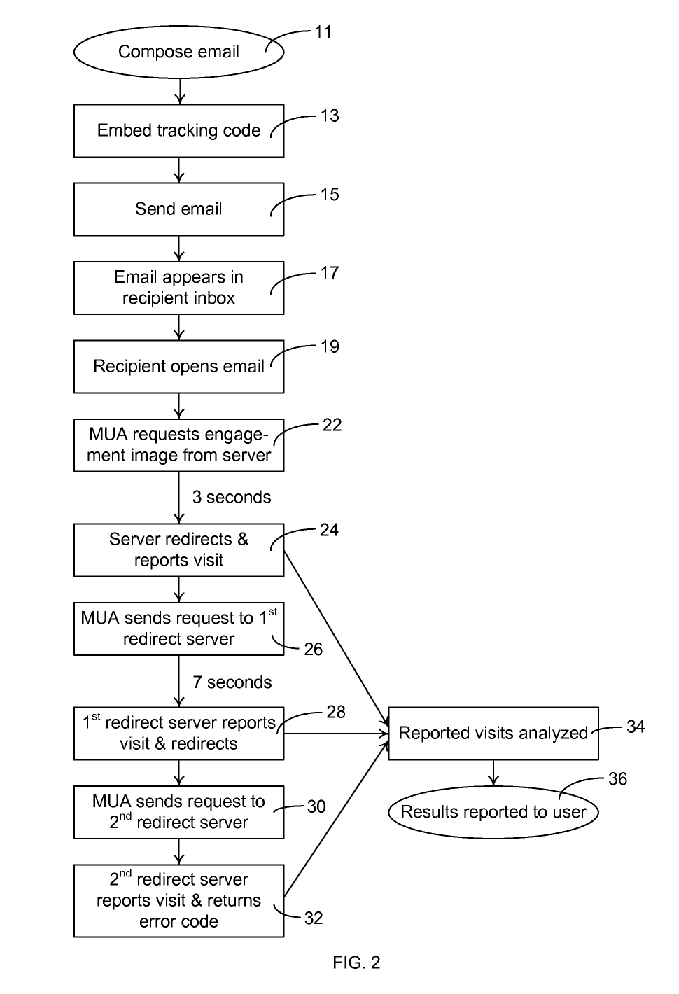

In one embodiment of an email communication, an author composes a message (step 11 in FIG. 2) using a mail user agent (“MUA”—e.g., a desktop mail client such as Microsoft Outlook or a web-based mail client, such as Gmail, Yahoo Mail, or Hotmail). The email addresses (e.g., in the format of john.doe@gmail.com) of the intended recipient(s) of the message can also be entered by the author; alternatively, a software program stored on a computer-readable medium can instruct a processor to enter email addresses for recipients based on pre-established criteria or groupings. The author may then click on a “send” icon generated as part of a graphical user interface generated by the mail user agent.

The mail user agent (MUA) formats the message in email format and uses the Simple Mail Transfer Protocol (SMTP) to send the message (step 15) to a local mail transfer agent (MTA), provided by, e.g., an internet service provider (ISP).

The MTA looks at the destination address provided in the SMTP protocol. The part before the @ sign of the email address is the local part of the address, often the username of the recipient, and the part after the @ sign is a domain name or a fully qualified domain name. The MTA resolves a domain name to determine the fully qualified domain name of the mail exchange server in the Domain Name System (DNS).

A DNS server for the destination domain responds with any mail exchange records listing the mail exchange servers for that domain; and the MTA sends the message to the recipient domain using SMTP, which delivers it to the mailbox of the designated recipient. The mail user agent (MUA) of the recipient picks up the message via Post Office Protocol (POP3) and the message then appears in the “inbox” (step 17) in the mail user agent (MUA) of the recipient for the user to view when the recipient logs on via, e.g., a personal computer.

### Overview of Email Analytics System and Methods

The email analytics system and methods of this disclosure enable email marketers to track the following behaviors of email message recipients:

how many people read the message;

how many people deleted the message;

how many people forwarded the message; and

what email client was used to read the message (Outlook, Gmail, etc.).

This tracking is achieved by having the email marketer embed a piece of tracking code (step 13) in their email newsletter. The tracking code builds on the existing principle of ‘image bug tracking’ that is currently used by most email marketing platforms to track the ‘open rate’ of an email campaign.

### Tracking Code

In one embodiment, the following code is embedded in the email newsletter. The unique identifier (highlighted in bold) will change for each campaign, but the rest of the code remains the same.

<style>@media print{#_t { background-image:
url(‘https://a5.emltrk.com/446EF4F5?p’);}} div.Section1,
b.gmail_sendername, table.moz-email-headers-table, span.Apple-
style-span, body.mceContentBody {background-image:
url(‘https://a5.emltrk.com/446EF4F5?f’)} </style><div id=“_t”>
</div><img src=“https://a5.emltrk.com/446EF4F5” style=
“display:none” width=“1” height=“1” border=“0” />

### Processing the Data

The tracking code, above, instructs the computer (client) 12 of the email recipient to request an image from web servers 12 when particular actions happen. When the email message is first opened, the recipient's mail user agent (MUA) requests an engagement image 22. When the email message is printed, the mail user agent requests a print image. When the email message is forwarded, every subsequent time the email message is opened by a recipient, each subsequent recipient's mail user agent requests a forward image.

### Engagement Image

The engagement image, which is requested 22 by the mail user agent (MUA) when the email message is first opened, is not actually served from the web servers. Instead, an initial-engagement server at the specified location (URL) holds open the HTTP connection (by keeping the TCP connection open but waiting to provide a response) and serves a redirect (302) response 24 to a first redirect location (the URL of which is given in the Location: header of the HTTP response) after a time period in the range from about 1-5 seconds (e.g., three seconds) have elapsed. The redirect response induces the client mail user agent (e.g., a browser operated on the user's computer) to send a request 26 to the first redirect location. The recipient's mail user agent (MUA) then requests 26 a second image from the first redirect location; the image again is not actually served from the web servers. Instead, the HTTP connection is again held open; and after a time period in the range from about 1-10 seconds (e.g., 7 seconds), the server at the redirect location serves a redirect response (302) 28 to induce the client mail user agent (MUA) to send a request 30 to a second redirect location.

Finally, if the client mail user agent (MUA) sends the request 30 to the second redirect location, the server at the second redirect location returns a 503 error code 32. The purpose of serving the error code 32 is to prevent the email client from caching, and therefore ensuring that should the recipient open the message again, this same process will be followed again. A schematic illustration of these communications is provided in FIG. 1, and a flow chart is provided in FIG. 2. In each case, the time period before the redirect response is sent can be customized based, e.g., on the content and length of the message.

In another embodiment, more than two redirect locations are used (e.g., 8 redirect locations); and the time delay periods are shorter (e.g., each 2 seconds in duration); in this embodiment, the recipient's behavior can be tracked in consecutive 2 second increments for up to about 20 seconds.

These multiple connection states allow tracking of the rough time that a recipient has had the email message open in their email client. The transmissions of the requests from the mail user agent can be tracked by reviewing the server traffic logs at each of the servers, which can track the source of each request from the location headers in the request. Code from web-based analytical applications, such as Google Analytics, can be incorporated into the various servers to track “visits” (i.e., requests) from recipients; and the resulting data can be readily reported to a user by the analytical application or accessed by a user via the internet by, e.g., visiting the website of Google Analytics and logging in with a user name and password that provides access to the traffic data. Code (e.g., javascript) incorporated into the web analytics code or otherwise provided on the server can track the time a recipient is connected with the server.

If we only see the first request (in the server traffic log at initial-engagement location on the server) from a particular recipient, then we know that the recipient looked at the email message for less than two seconds (when two-second delays are used). If we see the first and second request (where the recipient's location appears in the server traffic log at the first redirect location), then we know that the recipient looked at the email message for between 2 and 4 seconds in this embodiment. Similarly, with the tracking of each subsequent request at a redirect location, where the recipient's location appears in the server traffic logs, another 2 seconds can be added for the recorded length of time that the recipient looked at the email message. This data can be collected, summed and tabulated 34 over time via the analytical application or by other software stored on a computer-readable medium in the system and electronically reported 36 to a user over the internet.

### The Print Image

The print image is only revealed when the recipient's email client loads the print style sheet for the message. The print style sheet is loaded using the @ media print declaration in the tracking code. Since loading of the print style sheet is limited to this situation, the servers record a print hit whenever a request for this image is received. This data can likewise be collected, summed and tabulated over time via the analytical application or by other software stored on a computer-readable medium in the system and electronically reported to a user over the internet.

### The Forward Image

Using another cascading style sheet (CSS) declaration, the forward image is set to be the background image for specific elements present in the HTML of the email message. These CSS declarations are as follows:

div.Section1, b.gmail_sendername, table.moz-email-headers-table,
span.Apple-style-span, body.mceContentBody

These elements are only present when the email message has been forwarded, since they are elements added by various email clients to display text such as “Begin forwarded message”. When the servers see a request for the forward image, the request is recorded as a forward of this email campaign in our database. Again, this data can be collected, summed and tabulated over time via the analytical application or by other software stored on a computer-readable medium in the system and electronically reported to a user over the internet.

### Server-Side Techniques

Web-based email clients are detected by checking the HTTP header “Referrer”. From this header, we can see if the request came from one of the domains recognized as a web-based email client. For example, requests with a referrer of “mail.google.com” indicate that the email message was opened in Gmail's web-based interface. We also make use of the HTTP header “User-Agent”, which allows us to detect which browser the email message was opened in. Combining these two pieces of data allow us to conclude that an email message was opened in Gmail, using the Firefox browser, for example.

Desktop mail user agent clients do not leave HTTP “Referrer” headers, so we look at the User-Agent header. Each email client has a unique User-Agent header, such as “lotus-notes” for IBM's Lotus Notes email client. For Lotus Notes, we also use the HTTP protocol version (either “1.0” or “1.1”) to determine which version of Lotus Notes the email message was opened in.

For printing and forwarding detection, we monitor for and record requests to URLs with a query-string of either “?f” (to indicate the email message was forwarded) or “?p” (to indicate it was printed). These URLs are only requested when the email message is printed or forwarded, as described above; and the query string appears at the end of the URL.

Each of the above-described server-side monitoring techniques can be implemented via software stored on computer-readable media at the servers.

### What the User Sees

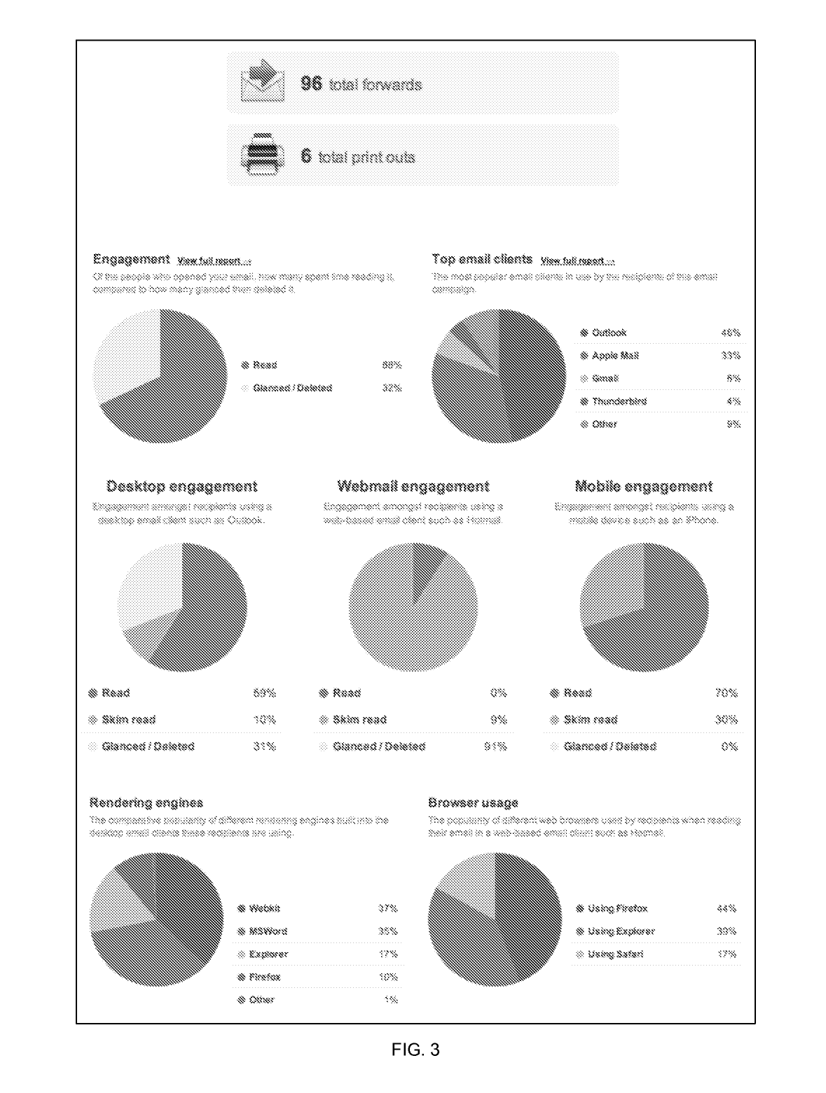

The end results of this tracking are collected from the servers, tabulated and presented in a series of reports that are delivered (e.g., electronically) to, e.g., the internet browser on the monitor of a computer of an email marketer. When a visit from a recipient is recorded only in the traffic log of the initial-engagement server, that recipient is recorded as having “glanced” at the message. When a visit from a recipient is also recorded in the traffic log of the first redirect server, that recipient is labeled as having “skim read” the message. When a visit from a recipient is also recorded in the traffic log of the second redirect server, that recipient is labeled as having “read” the message. These reports help the marketer better understand the response to their email campaign. An example presentation with these reports is shown in FIG. 3.

In describing embodiments of the invention, specific terminology is used for the sake of clarity. For the purpose of description, specific terms are intended to at least include technical and functional equivalents that operate in a similar manner to accomplish a similar result. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Further, where parameters for various properties are specified herein for embodiments of the invention, those parameters can be adjusted up or down by 1/100^{th}, 1/50^{th}, 1/20^{th}, 1/10^{th}, ⅕^{th}, ⅓^{rd}, ½, ¾^{th}, etc. (or up by a factor of 2, 5, 10, etc.), or by rounded-off approximations thereof, unless otherwise specified. Moreover, while this invention has been shown and described with references to particular embodiments thereof, those skilled in the art will understand that various substitutions and alterations in form and details may be made therein without departing from the scope of the invention. Further still, other aspects, functions and advantages are also within the scope of the invention; and all embodiments of the invention need not necessarily achieve all of the advantages or possess all of the characteristics described above. Additionally, steps, elements and features discussed herein in connection with one embodiment can likewise be used in conjunction with other embodiments. The contents of references, including reference texts, journal articles, patents, patent applications, etc., cited throughout the text are hereby incorporated by reference in their entirety; and appropriate components, steps, and characterizations from these references may or may not be included in embodiments of this invention. Still further, the components and steps identified in the Background section are integral to this disclosure and can be used in conjunction with or substituted for components and steps described elsewhere in the disclosure within the scope of the invention. In method claims, where stages are recited in a particular order—with or without sequenced prefacing characters added for ease of reference—the stages are not to be interpreted as being temporally limited to the order in which they are recited unless otherwise specified or implied by the terms and phrasing.

What is claimed is:

1. A method for email analytics comprising:
sending an email message that includes a tracking code that requests content from an initial-engagement location, wherein the tracking code requests the content from the initial-engagement location when the email message is opened by a mail user agent operated by a recipient;
tracking requests sent to the initial-engagement location to measure the number of recipients that open the email message;
serving a first redirect response from the initial-engagement location to the mail user agent of the recipient after a first delay period to cause the mail user agent of the recipient to then request content from a first redirect location; and
tracking requests sent to the first redirect location to measure the number of recipients that keep the email message open in the mail user agent through all of the first delay period.

2. The method of claim 1, wherein the first delay period is in the range from about 1 to about 5 seconds.

3. The method of claim 1, further comprising:
serving a second redirect response from the initial-engagement location to the mail user agent of the recipient after a second delay period to cause the mail user agent of the recipient to then request content from a second redirect location; and
tracking requests sent to the second redirect location to measure the number of recipients that keep the email message open in the mail user agent through all of the second delay period.

4. The method of claim 3, wherein the second delay period is in the range from about 1 to about 10 seconds.

5. The method of claim 3, wherein each delay period is about 2 seconds.

6. The method of claim 3, further comprising serving an error code from a final redirect location to the mail user agent of the recipient.

7. The method of claim 1, wherein the requested content includes one or more image files;

8. The method of claim 1, further comprising sending a report of the tracked requests at each location to a user.

9. The method of claim 1, wherein the tracking code further includes a declaration to load a print style sheet from the server when a recipient prints the email message; the method further comprising tracking the number of times that the print style sheet is requested.

10. The method of claim 1, wherein the tracking code further includes a declaration that recognizes at least one element that indicates that an email message has been forwarded to a new recipient and causes the mail user agent to send a forward-specific request when the element is present in the message, the method further comprising tracking the number forward-specific requests received.

11. A method for email analytics comprising:
providing at least one server hosting a plurality of locations;
receiving a first request for content from a mail user agent at an initial-engagement location on the server;
holding open the connection between the mail user agent and the server for a first delay period after the first request is received;
after expiration of the first delay period, sending a first redirect response from the server to the mail user agent to cause the mail user agent to send a second request for content to a first redirect location on the server;
tracking the requests received, respectively, at the initial-engagement location and at the first redirect location; and
generating a report indicating how long the message was open for each recipient based on the request tracking.

12. The method of claim 11, further comprising:
holding open the connection between the mail user agent and the server for a second delay period after the second request is received;
after expiration of the second delay period, sending a second redirect response from the server to the mail user agent to cause the mail user agent to send a third request for content to a second redirect location on the server; and
tracking the requests received at the second redirect location.

13. The method of claim 12, wherein the delay periods are in the range from about 1 to about 10 seconds.

14. An apparatus including at least one server and at least one non-transitory computer-readable storage medium having stored thereon a computer program for email analytics, the computer program comprising a routine set of instructions, which when executed by a computer machine, cause the computer machine to perform the steps of:
tracking requests for content received from mail user agents at an initial-engagement location on the server;
sending a first redirect response from the server to the mail user agent after a first delay period directing the mail user agent to request content from a first redirect location;
tracking requests for content received from mail user agents at the first redirect location; and
generating a report indicating time periods over which an email message was kept open by different recipients based on the tracking of requests.

15. The apparatus of claim 14, wherein the computer program further comprises instructions for:
sending a second redirect response from the server to the mail user agent after the second delay period directing the mail user agent to request content from a second redirect location;
tracking requests for content received from mail user agents at the second redirect location.

16. The apparatus of claim 15, wherein the delay periods are in the range from about 1 to about 10 seconds.

17. The apparatus of claim 15, wherein the computer program further comprises instructions for sending an error code from the server to the mail user agent after receiving a request for content from the mail user agent at a final redirect location.
